(19) United States
(12) Patent Application Publication
(10) Pub. No.: US 2007/0184694 A1
(43) Pub. Date: Aug. 9, 2007

(54) Wiring structure, semiconductor device and methods of forming the same

(76) Inventors: Jong-Kyu Kim, Seoul (KR); Jong-Chul Park, Suwon-si (KR); Jang-Bin Yim, Yongin-si (KR); Sang-Dong Kwon, Suwon-si (KR); Ki-Jeong Kim, Yongin-si (KR); Sung-Gil Choi, Yongin-si (KR)

Correspondence Address: HARNESS, DICKEY & PIERCE, P.L.C., P.O. BOX 8910, RESTON, VA, 20195, US

(21) Appl. No.: 11/592,242

(22) Filed: Nov. 3, 2006

(30) Foreign Application Priority Data
Nov. 4, 2005 (KR) 2005-105330

(51) Int. Cl. H01R 3/08

(52) U.S. Cl. 439/179

(57) ABSTRACT

Example embodiments relate to a wiring structure, a semiconductor device and methods of forming the wiring structure. The wiring structure may include a first contact plug, a second contact plug, a protecting layer pattern and an insulating structure. The first contact plug may be provided on a semiconductor substrate. The second contact plug may be provided on the first contact plug to be electrically connected to the first contact plug. The protecting layer pattern may encompass an upper sidewall of the first contact plug and a sidewall of the second contact plug to retard chemicals from infiltrating into an interface between the first and second contact plugs. The insulating structure may encompass the first contact plug, the second contact plug and the protecting layer pattern.

### PRIORITY STATEMENT

This application claims benefit of priority under 35 U.S.C. § 119 to Korean Patent Application No. 10-2005-0105330 filed on Nov. 4, 2005, in the Korean Intellectual Property Office (KIPO), the entire contents of which are incorporated herein by reference.

### BACKGROUND

1. Field

Example embodiments relate to a wiring structure, a semiconductor device and methods of forming the wiring structure. Other example embodiments relate to a wiring structure with relatively few defects (e.g. chemical removal, reduced connection) that may cause an operation failure of a highly integrated semiconductor device, a semiconductor device and methods of forming the same.

2. Description of the Related Art

As information technology devices (e.g., a computer) have become more widespread, a semiconductor device, included in the information technology devices, has been developed. A semiconductor device having improved functions (e.g., an improved performance speed and/or a relatively large storage capacity) may be needed. In order to meet these requirements, the semiconductor device may become more highly integrated and more able to store a larger amount of information. To achieve a more highly integrated semiconductor device, a design rule may be shrunk in manufacturing the semiconductor device (e.g., a dynamic random access memory (DRAM) device). In the DRAM device, wires may be connected to each other by a contact. Because the design rule of the DRAM device is shrunk, an area of the contact making electrical contact with a wire may also be shrunk and contact resistance may increase in the DRAM device. The contact may cause an operation failure of the DRAM device.

A lay out of a DRAM cell may be changed from an 8F2 (F: minimum feature size) structure into a 6F2 structure having a diagonal active region. In the 6F2 structure, an interval between the wires and an interval between the contacts may be relatively small. In case a change occurs in processes required for achieving the 6F2 structure, defects may be easily generated. For example, a reduced connection of a bit line contact, which links a bit line to a landing pad electrically, may occur more frequently.

FIG. 1 is a diagram illustrating a reduced connection between contact plugs according to the conventional art. Referring to FIG. 1, a capacitor contact (not shown) connecting a lower electrode of a capacitor to a capacitor landing pad may be formed. A dry etching process may be initially performed so that an upper portion of the capacitor landing pad is exposed. A wet etching process may then be performed to increase an area where the capacitor contact makes contact with the capacitor landing pad. A bit line landing pad 14, a bit line (not shown) and a bit line contact 20, connected between the bit line landing pad 14 and the bit line, may be formed in a previous process. An etching process required for forming the capacitor contact may be a self-alignment process. When the capacitor contact is formed, a spacer formed on a sidewall of the bit line may guide the capacitor contact. In FIG. 1, reference numerals 10, 12, 18 and 22 indicate a semiconductor substrate, a first insulating interlayer, a second insulating interlayer and a barrier metal layer.

The wet etching process may be performed in order to increase the area where the capacitor contact makes contact with the capacitor landing pad. However, the chemicals used in the wet etching process may infiltrate into an interface between the bit line landing pad 14 and the bit line contact 20. A metal silicide layer pattern, used as an ohmic layer pattern, may be provided at a lower face portion of the bit line contact 20 and may be partially removed by the chemicals. If the metal silicide layer pattern is partially removed, a space 16 may be formed between the bit line landing pad 14 and the bit line contact 20. Because of the space 16, the bit line landing pad 14 may not be efficiently connected to the bit line contact 20. Contact resistance between the bit line landing pad 14 and the bit line contact 20 may become relatively large, thereby interrupting the connection. In case that the space 12 is large, the bit line landing pad 14 may not electrically contact with the bit line contact 20.

### SUMMARY

Example embodiments relate to a wiring structure, a semiconductor device and methods of forming the wiring structure.

In accordance with some example embodiments, a wiring structure may include a first contact plug, a second contact plug, a protecting layer pattern and an insulating structure. The first contact plug may be provided on a semiconductor substrate. The second contact plug may be provided on the first contact plug to be electrically connected to the first contact plug. The protecting layer pattern may encompass an upper sidewall of the first contact plug and a sidewall of the second contact plug to reduce the amount of chemicals from infiltrating into an interface between the first and second contact plugs. The insulating structure may encompass the first contact plug, the second contact plug and the protecting layer pattern.

In accordance with some example embodiments, there may be provided a method of forming a wiring structure of a semiconductor device. In the method, a first insulating interlayer may be formed on a semiconductor substrate. A first contact plug may be formed through the first insulating interlayer. A second insulating interlayer may be formed on the first insulating interlayer. A hole may be formed exposing an upper face of the first contact plug and an upper sidewall of the first contact plug by partially etching the first and second insulating interlayers. A protecting layer pattern may be formed encompassing the exposed upper sidewall of the first contact plug. The protecting layer pattern may have an upper face higher than an upper face of the first contact plug. A second contact plug may be formed in the hole. The second contact plug may make electrical contact with the first contact plug.

According to example embodiments, there may be provided another method of forming a wiring structure of a semiconductor device. A preliminary first insulating interlayer may be formed including a preliminary contact plug on semiconductor substrate. An etch-back process may be performed on an upper portion of the preliminary first insulating interlayer to form a first insulating interlayer covering a lower sidewall of the preliminary first contact plug such that an upper sidewall of the preliminary first contact plug is exposed. A protecting layer pattern may be formed on the first insulating interlayer having an upper face coplanar with an upper face of the preliminary first contact plug. An etch-back process may be performed on an upper portion of the preliminary first contact plug to form a first contact plug having a height lower than that of the preliminary first contact plug. A second insulating interlayer may be formed on the protecting layer pattern and the first insulating interlayer, the second insulating interlayer having a hole exposing a sidewall of the protecting layer pattern and an upper face of the first contact plug. A second contact plug may be formed on the first contact plug to make electrical contact with the first contact plug, the second contact plug filling the hole.

According to example embodiments, there may be a semiconductor device comprising a substrate, an isolation layer dividing the substrate into an isolation region and a plurality of active regions, gate structures on the isolation region and the active regions, a metal oxide semiconductor (MOS) transistor on the active regions that includes first and second impurity regions located below opposite sides of the gate structures, a bit line coming into electrical contact with the first impurity region and a capacitor coming into electrical contact with the second impurity region, a first insulating interlayer covering the gate structures, first holes formed through the first insulating interlayer exposing the first impurity region or the second impurity region and the wiring structure according to example embodiments.

According to example embodiments, there may also be a method of manufacturing a semiconductor device comprising forming an isolation layer in a surface of a semiconductor substrate that may divide the semiconductor substrate into a field region and a plurality of active regions, forming gate structures on the field region and the active regions, sequentially forming a buffer oxide layer and silicon nitride layer on the semiconductor substrate, etching the silicon nitride layer to form a silicon nitride layer pattern, removing the silicon nitride layer pattern and the buffer oxide layer pattern by a wet etching process, forming first and second impurity regions on a surface of the active region located below opposite sides of the gate structures, electrically connecting a bit line and the first impurity region, and a capacitor and the second impurity region and forming a wiring structure according to example embodiments.

According to example embodiments, a wiring structure may include a protecting layer pattern encompassing an upper sidewall of a first contact plug and a sidewall of a second contact plug. Because of the protecting layer pattern, a metal silicide layer pattern formed at a lower face portion of the second contact plug may not be exposed. The protecting layer pattern may reduce the amount of chemicals capable of melting the first and second contact plugs from infiltrating between the first and second contact plugs when the chemicals are provided around the first and second contact plugs. Damage (e.g. melting and/or erosion) to the metal silicide layer pattern due to the chemicals may be reduced or prevented.

### BRIEF DESCRIPTION OF THE DRAWINGS

The example embodiments will be more clearly understood from the following detailed description taken in conjunction with the accompanying drawings. FIGS. 1-25 represent non-limiting, the example embodiments as described herein.

FIG. 1 is a diagram illustrating a reduced connection between contact plugs in a conventional wiring structure of a semiconductor device;

FIG. 2 is a diagram illustrating a wiring structure of a semiconductor device in accordance with example embodiments;

FIG. 3 is a diagram illustrating the wiring structure in FIG. 2 according to example embodiments;

FIGS. 4 to 7 are diagrams illustrating a method of forming the wiring structure in FIG. 2 according to example embodiments;

FIG. 8 is a diagram illustrating a wiring structure in accordance with example embodiments;

FIGS. 9 to 13 are diagrams illustrating a method of manufacturing the wiring structure of the semiconductor device in FIG. 8 according to example embodiments;

FIG. 14 is a diagram illustrating a wiring structure of a semiconductor device in accordance with example embodiments;

FIGS. 15 to 18 are diagrams illustrating a method of forming the wiring structure of the semiconductor device in FIG. 14 according to example embodiments;

FIG. 19 is a diagram illustrating a dynamic random access memory (DRAM) device including the wiring structure in FIG. 1 in accordance with example embodiments;

FIG. 20 is a diagram taken along line I-I′ in FIG. 19 according to example embodiments; and

FIGS. 21 to 25 are diagrams illustrating a method of manufacturing the DRAM device in FIG. 20 according to example embodiments.

### DESCRIPTION OF EXAMPLE EMBODIMENTS

Example embodiments will be described with reference to the accompanying drawings. Example embodiments may, however, be embodied in many different forms and should not be construed as limited to the embodiments set forth herein. Rather, the embodiments are provided so that disclosure of the example embodiments will be thorough and complete, and will fully convey the scope of example embodiments to those skilled in the art. The principles and features of example embodiments may be employed in varied and numerous embodiments without departing from the scope of example embodiments. In the drawings, the size and relative sizes of layers and regions may be exaggerated for clarity. The drawings are not to scale. Like reference numerals designate like elements throughout the drawings.

It will also be understood that when an element or layer is referred to as being “on,” “connected to” and/or “coupled to” another element or layer, the element or layer may be directly on, connected and/or coupled to the other element or layer or intervening elements or layers may be present. In contrast, when an element is referred to as being “directly on,” “directly connected to” and/or “directly coupled to” another element or layer, no intervening elements or layers are present. As used herein, the term “and/or” may include any and all combinations of one or more of the associated listed items.

It will also be understood that, although the terms first, second, etc. may be used herein to describe various elements, components, regions, layers and/or sections. These elements, components, regions, layers and/or sections should not be limited by these terms. These terms may be used to distinguish one element, component, region, layer and/or section from another element, component, region, layer and/or section. For example, a first element, component, region, layer and/or section discussed below could be termed a second element, component, region, layer and/or section without departing from the teachings of example embodiments.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (rotated 90 degrees or at other orientations) and the spatially relative descriptors used herein interpreted accordingly.

The terminology used herein is for the purpose of describing particular embodiments only and is not intended to limit the example embodiments. As used herein, the singular terms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical and scientific terms) used herein may have the same meaning as what is commonly understood by one of ordinary skill in the art. It will be further understood that terms, such as those defined in commonly used dictionaries, should be interpreted as having a meaning that is consistent with their meaning in the context of this specification and the relevant art and will not be interpreted in an idealized and/or overly formal sense unless expressly so defined herein.

Example embodiments are described with reference to cross-section illustrations that are schematic illustrations of idealized embodiments. As such, variations from the shapes of the illustrations as a result, for example, of manufacturing techniques and/or tolerances, are to be expected. Example embodiments should not be construed as limited to the particular shapes of regions illustrated herein but are to include deviations in shapes that result, for example, from manufacturing. For example, a region illustrated as a rectangle will, typically, have rounded or curved features. The regions illustrated in the figures are schematic in nature of a device and are not intended to limit the scope of example embodiments.

Unless otherwise defined, all terms (including technical and scientific terms) used herein have the same meaning as commonly understood by one of ordinary skill in the art to which the example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments relate to a wiring structure, a semiconductor device and methods of forming the wiring structure.

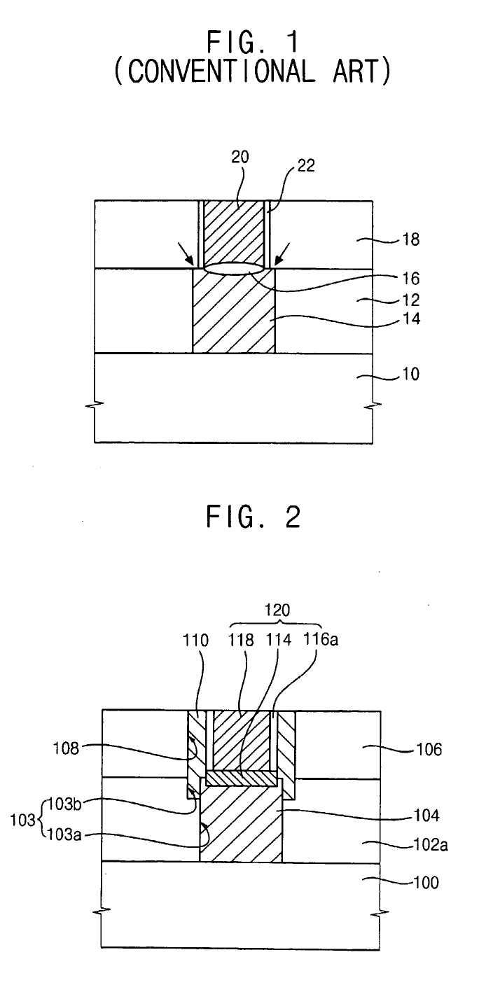

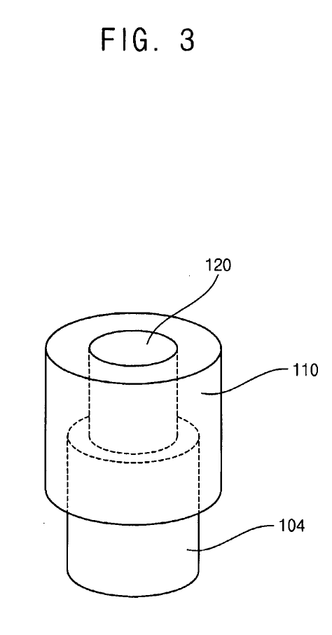

FIGS. 2 and 3 are diagrams illustrating a wiring structure of a semiconductor device in accordance with example embodiments. Referring to FIGS. 2 and 3, a first insulating interlayer 102a may be provided on a semiconductor substrate 100. The first insulating layer 102a may have holes 103 exposing a contact region of the semiconductor substrate 100. A lower structure (e.g., a metal oxide semiconductor (MOS) transistor) may be formed on the semiconductor substrate 100. The contact region may be an impurity region used as a source/drain region of the MOS transistor. The first insulating interlayer 102a may include silicon oxide. The holes 103 may include a first hole 103a and a second hole 103b. The first hole 103a and the second hole 103b may be in contact with each other. The first hole 103a and the second hole 103b may have a first width and a second width, respectively. The second width may be larger than the first width.

A first contact plug 104 may be provided in the holes 103. The first contact plug 104 may include polysilicon doped with impurities. An upper sidewall of the first contact plug 104 may not be encompassed by the first insulating interlayer 102a so that the upper sidewall is exposed. The first contact plug 104 fills the first hole 103a and extends into the second hole 103b.

A second insulating interlayer 106 may be provided on the first insulating interlayer 102a. The second insulating interlayer 106 may have a third hole 108 exposing an upper face of the first contact plug 104. The second insulating interlayer 106 may include silicon oxide. The third hole 108 may be in contact with the second hole 103b and have the same width as the second hole 103b.

A second contact plug 120 may be provided inside the third hole 108. The second contact plug 120 may be electrically connected to the first contact plug 104. Dimensions of the second contact plug 120 may be smaller than those of the third hole 108. The second contact plug 120 may be inserted into the third hole 108 such that the second contact plug 120 is spaced apart from a sidewall of the third hole 108. The second contact plug 120 may include a metal having an electrical resistance lower than that of polysilicon.

The second contact plug 120 may include a metal silicide layer pattern 114, a metal layer pattern 118 and a barrier metal layer pattern 116a. The metal silicide layer pattern 114 may be an ohmic layer pattern making direct contact with the first contact plug 104. The metal layer pattern 118 may be formed on the metal silicide layer pattern 114. The barrier metal layer pattern 116a may be formed on a sidewall of the metal layer pattern 118. The barrier metal layer pattern 116a may have a thickness of a few angstroms to hundreds of angstroms. The barrier metal layer pattern 116a may retard or prevent a diffusion of metal.

The metal silicide layer pattern 114 may be formed by chemical reactions between metal included in a barrier metal layer and polysilicon included in the first contact plug 104. The chemical reactions may occur when the barrier metal layer is formed. The barrier metal layer pattern 116a may include a titanium film pattern and a titanium nitride film pattern. Also, the barrier metal layer 116a may include a tantalum film and a tantalum nitride film. When the metal silicide layer pattern 114 includes titanium, the metal silicide layer pattern 114 may include titanium silicide. When the metal silicide layer pattern 114 includes tantalum, the metal silicide layer pattern 114 may include tantalum silicide. The metal layer pattern 118 may include tungsten, aluminum and/or copper. For example, the barrier metal layer pattern 116a may include the titanium film pattern and the titanium nitride film pattern. The metal silicide layer pattern 114 may include titanium silicide. The metal layer pattern 118 may include tungsten.

A protecting layer pattern 110 may be provided. The protecting layer pattern 110 may have a tubular shape such that the protecting layer pattern 110 encompasses the upper sidewall of the first contact plug 104 and a sidewall of the second contact plug 120. The protecting layer pattern 110 may retard or prevent chemicals, used in a cleaning process and/or an etching process, from infiltrating between the first and second contact plugs 104. The protecting layer pattern 110 may include a material that may not be removed while the first and second insulating interlayers 102a and 106 are etched. For example, if the first and second insulating interlayer 102a and 106 include silicon oxide, the protecting layer pattern 110 may include silicon nitride.

The protecting layer pattern 110 may encompass the sidewall of the second contact plug 120 entirely. The second contact plug 120 may not be electrically connected to neighboring contacts. An electrical short may not be generated between the second contact plug 120 and the neighboring contacts. The protecting layer pattern 110 may encompass an interface between the first and second contact plugs 104 and 120. Chemicals used in succeeding processes may not infiltrate into the interface between the first and second contact plugs 104 and 120. Defects generated by chemical reactions between the chemicals and metal silicide around the interface may be reduced. Because the defects are reduced, an operation failure of a semiconductor device, due to an increase of contact resistance, may decrease.

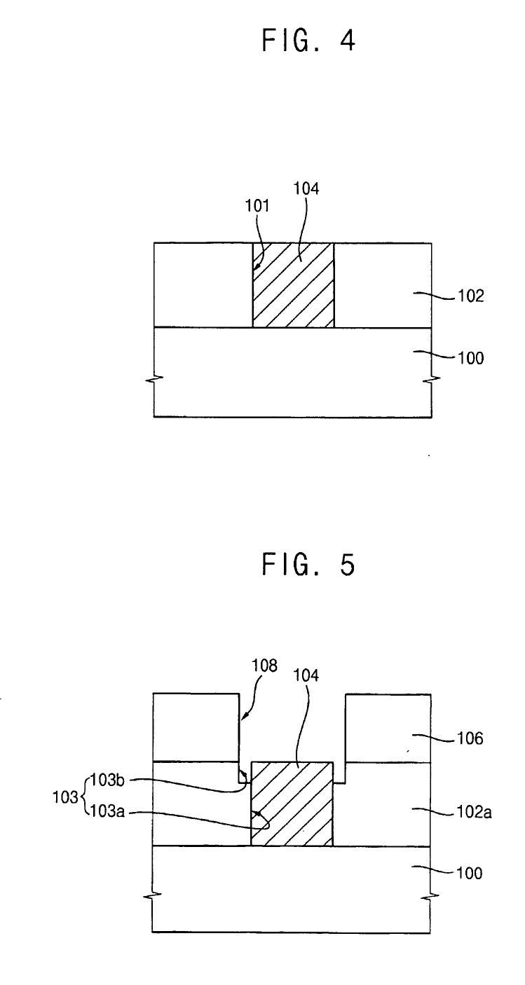

FIGS. 4 to 7 are diagrams illustrating a method of forming the wiring structure in FIG. 2 in accordance with example embodiments. Referring to FIG. 4, a semiconductor substrate 100 may be prepared. The semiconductor substrate 100 may have a contact region. The contact region may be an impurity region used as a source/drain region of a MOS transistor. A preliminary first insulating interlayer 102 including silicon oxide may be formed on the semiconductor substrate 100. The preliminary first insulating interlayer 102 may be partially etched so that a preliminary first hole 101 may be formed through the preliminary first insulating interlayer 102. The preliminary first hole 101 exposes the contact region. A dry etching process may be performed on the preliminary first insulating interlayer 102 in order to form the preliminary first hole 101. A doped polysilicon layer with impurities may be formed on the preliminary first insulating interlayer 102 to fill the preliminary first hole 101. The doped polysilicon layer may be planarized until the preliminary first insulating interlayer 102 is exposed. A first contact plug 104 may be formed in the preliminary first hole 101.

Referring to FIG. 5, a preliminary second insulating interlayer (not shown) including silicon oxide may be formed on the preliminary first insulating interlayer 102 through which the first contact plug 104 may be formed. The preliminary first insulating interlayer 102 and the preliminary second insulating interlayer may be partially etched such that an upper face and an upper sidewall of the first contact plug 104 may be exposed. The preliminary second insulating interlayer may be transformed into a second insulating interlayer 106 having a hole 108. The preliminary first insulating interlayer 102 may be transformed into a first insulating interlayer 102a having holes 103. The holes 103 may include a first hole 103a and a second hole 103b. The first hole 103a and the second hole 103b may correspond to a lower portion of the holes 103 and an upper portion of the holes 103, respectively. The first hole 103a and the second hole 103b may be communicated with each other. The first hole 103a and the second hole 103b have a first width and a second width, respectively. The second width may be larger than the first width. There may be a gap between the upper sidewall of the first contact plug 104 and an inner face of the second hole 103. A space defined by the upper sidewall of the first contact plug 104 and the inner face of the second hole 103b may have a ring shape.

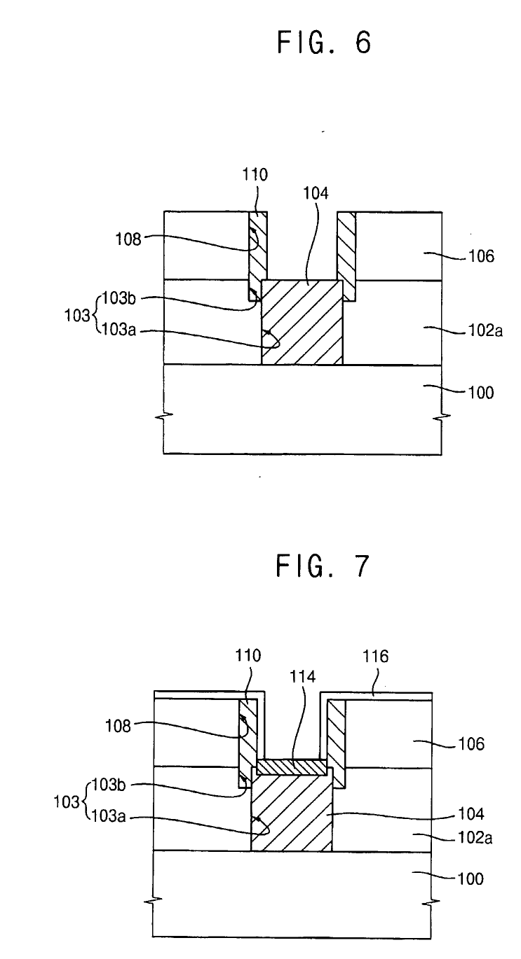

Referring to FIG. 6, a protecting layer (not shown) may be formed on an upper face of the second insulating interlayer 106, a sidewall of the hole 108, the inner face of the second hole 103b, the upper sidewall of the first contact plug 104, the upper sidewall of the first contact plug 104 and the upper face of the first contact plug 104 so that the protecting layer fills the space defined by the inner face of the second hole 103b and the upper sidewall of the first contact plug 104. The protecting layer may include a material capable of achieving conformal step coverage. Voids may not be generated while the protecting layer fills the space defined by the inner face of the second hole 103b and the upper sidewall of the first contact plug 104. A width of the protecting layer may be smaller than half of the second width of the hole 108. The hole 108 may not be filled with the protecting layer.

The protecting layer may be transformed into a protecting layer pattern 110 by succeeding processes. The protecting layer pattern 110 may retard or prevent etching solutions, used in etching the first and second insulating interlayers 102a and 106, from infiltrating between the first contact plug 104 and the second contact plug 120 (see FIG. 2). The protecting layer may be desirably formed by using materials having a relatively high etching selectivity with respect to silicon oxide. Silicon oxide may be the material used in forming the first and the second insulation layer in order to retard or prevent the protecting layer from being etched while wet etching the first and the second insulation layer.

The protecting layer may be anisotropically etched so that portions of the protecting layer (e.g., the portions existing on the upper face of the second insulating interlayer 106 and the upper face of the first contact plug 104) may be selectively removed. The protecting layer may be transformed into the protecting layer pattern 110. The protecting layer pattern 110 may be formed on the sidewall of the hole 108, the inner face of the second hole 103b and the upper sidewall of the first contact plug 104. The protecting layer pattern 110 may have a tubular shape. The protecting layer pattern may extend upward. As described above, the protecting layer pattern 110 may retard or prevent the etching solutions, used in etching the first and second insulating interlayers 102a and 106, from infiltrating between the first contact plug 104 and the second contact plug 120 (see FIG. 2).

Referring to FIG. 7, barrier metal materials may be continuously deposited on the upper face of the second insulating interlayer 106, an upper face and a sidewall of the protecting layer pattern 110, and an upper face of the first contact plug 104. The barrier metal materials may be deposited by a chemical vapor deposition (CVD) process and/or any other suitable process. The barrier metal material may be deposited at a relatively high temperature. The barrier metal material may chemically react with polysilicon included in the first contact plug 104 so that a metal silicide layer pattern 114 may be formed on the upper face of the first contact plug 104. The metal silicide layer pattern 114 may correspond to an ohmic layer pattern reducing contact resistance. A preliminary barrier metal layer pattern 116 may be formed on the upper face of the second insulating interlayer 106, the upper face of the protecting layer pattern 110 and the sidewall of the protecting layer pattern 110. The preliminary barrier metal layer pattern 116 may include a titanium nitride film pattern and/or a titanium nitride film pattern. In other example embodiments, the preliminary barrier metal layer pattern 116 may include a tantalum nitride film pattern and/or a tantalum film pattern.

Referring again to FIG. 2, a metal layer (not shown) may be formed on the second insulating interlayer 106 to fill the hole 108. The metal layer may include tungsten, aluminum and/or copper. The metal layer and the preliminary barrier metal layer pattern 116 may be planarized until the second insulating interlayer 106 is exposed. A metal layer pattern 118 and a barrier metal layer pattern 116a may be formed. A second contact plug 120 including the metal silicide layer pattern 114, the metal layer pattern 118 and the barrier metal layer pattern 116a may be formed. The metal layer pattern 118 may be formed on the metal silicide layer pattern 114. The barrier metal layer pattern 116a may be formed on the metal silicide layer pattern 114 and the sidewall of the metal layer pattern 118.

In example embodiments, the metal layer and the preliminary barrier metal layer may be partially removed to form a conductive line, the metal layer pattern 118 and the barrier metal layer pattern 116a. The conductive line may be connected to the metal layer pattern 108 and the barrier metal layer pattern 116a. The conductive line may extend in a certain direction on the second insulating interlayer 106. The conductive line may have a bar shape. According to example embodiments, the conductive line electrically connected to the second contact plug 120 may be formed simultaneously with the second contact plug 120.

As described above, the protecting layer pattern 110 having a tubular shape may be formed on a sidewall of the first contact plug 104 and the sidewall of the second contact plug 120, which is formed on and electrically connected to the first contact plug 104. The protecting layer pattern 110 may retard or prevent etching solutions, used for etching the first and second insulating interlayers 102a and 106, from infiltrating between the first and second contact plugs 104 and 120. Material in the first contact plug 104 and/or the second contact plug 120 may be retarded or prevented from chemically reacting with the etching solutions. For example, the protecting layer pattern 120 may retard or prevent the metal silicide layer pattern 114 from being chemically reacted with the etching solutions. Defects (e.g., melting and/or erosion) and contact resistance may be reduced.

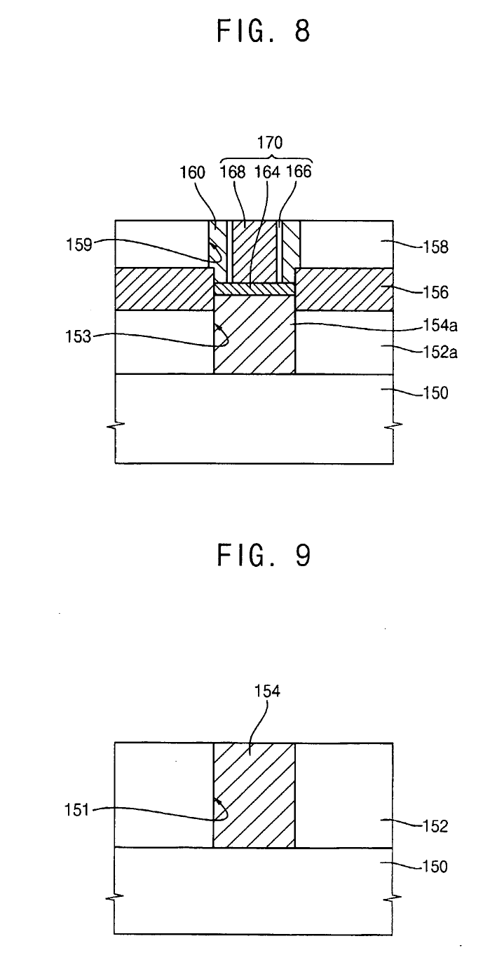

FIG. 8 is a diagram illustrating a wiring structure in accordance with example embodiments. Referring to FIG. 8, a first insulating interlayer 152a may be formed on a semiconductor substrate 150 having a contact region. The first insulating interlayer 152a may have a first hole 153 exposing the contact region of the semiconductor substrate 150. A lower structure (e.g., a MOS transistor) may be formed on the semiconductor substrate 150. The contact region may be an impurity region used as a source/drain region of the MOS transistor. The first insulating interlayer 152a may include silicon oxide. A first contact plug 154a, having an upper face higher than an upper face of the first insulating interlayer 152a, may be formed in the first hole 153. The first contact plug 154a may include polysilicon doped with impurities. A protecting layer pattern 156 may be formed on the first insulating interlayer 152a to fill a gap between the first contact plugs 154a. The protecting layer pattern 156 may have an upper face higher than the upper face of the first contact plug 154a. The protecting layer pattern 156 may include silicon nitride.

A second insulating interlayer 158 may be formed on the protecting layer pattern 156. The second insulating interlayer 158 may have a second hole 159. The second hole 159 may expose all of the upper face of the first contact plug 154a. An upper sidewall of the protecting layer pattern 156 may be exposed by the second hole 159. A spacer 160 may be formed on a sidewall of the second hole 159 such that the spacer 160 may cover the upper sidewall of the protecting layer pattern 156. The spacer 160 may include the same material as the protecting layer pattern 156.

A second contact plug 170 including metal may be provided in the second hole 159 partially filled with the spacer 160. The second contact plug 170 may include a metal silicide layer pattern 164, a metal layer pattern 168 and a barrier metal layer pattern 166. The metal silicide layer pattern 164 may be an ohmic layer pattern making direct contact with the first contact plug 154a. The metal layer pattern 168 may be provided on the metal silicide layer pattern 164. The barrier metal layer pattern 166 may be formed on a sidewall of the metal layer pattern 168. The barrier metal layer pattern 166 may have a thickness of about a few angstroms to about hundreds of angstroms. The barrier metal layer pattern 166 may retard or prevent a diffusion of the metal. Because of the spacer 160, the second contact plugs 170 adjacent to each other may not be electrically connected to each other.

As described above, the protecting layer pattern 156 may encompass an interface between the first and second contact plugs 154a and 170. The protecting layer pattern 156 may retard or prevent etching solutions (e.g. a wet etching solution) from infiltrating between the first and second contact plugs 154a and 170. The metal silicide layer pattern 164 may not chemically react with the etching solutions and defects (e.g., melting and/or erosion) may be reduced.

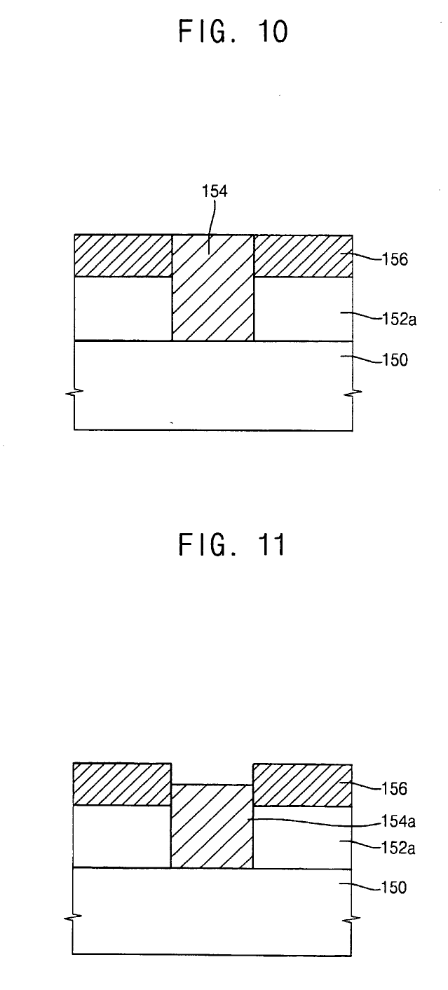

FIGS. 9 to 13 are diagrams illustrating a method of manufacturing a wiring structure of a semiconductor device in FIG. 8 according to example embodiments. Referring to FIG. 9, a semiconductor substrate 150 having a contact region may be prepared. Although not illustrated in FIG. 9, a lower structure (e.g., a MOS transistor) may be formed on the semiconductor substrate 150. A preliminary first insulating interlayer 152 including silicon oxide may be formed on the semiconductor substrate 150. The preliminary first insulating interlayer 152 may be transformed into an insulating interlayer 152a (see FIG. 10). The preliminary first insulating interlayer 152 may have a height higher than a height of the insulating interlayer 152a (see FIG. 10). The height of the preliminary first insulating interlayer 152 may be more than the height of the preliminary insulating interlayer 152a (see FIG. 10) by about 300 Å to about 3,000 Å.

The preliminary first insulating interlayer 152 may be partially etched so that a preliminary first hole 151 exposing the contact region may be formed through the preliminary first insulating interlayer 152. The preliminary first insulating interlayer 152 may be partially etched by a dry etching process.

A doped polysilicon layer with impurities may be formed on the preliminary first insulating interlayer 152 to fill the preliminary first hole 151. The doped polysilicon layer may be then planarized until the preliminary first insulating interlayer 152 is exposed. A preliminary first contact plug 154 may be formed in the preliminary first hole 151.

Referring to FIG. 10, an etch-back process may be performed on the preliminary first insulating interlayer 152. The preliminary first insulating interlayer 152 may be transformed into the first insulating interlayer 152a having the height smaller than the height of the preliminary first insulating interlayer 152. The preliminary first contact plug 154 may protrude as much as the preliminary first insulating interlayer 152 may be removed by the etch-back process. There may be a gap between the preliminary first contact plugs 154.

A thickness of a portion of the preliminary first insulating interlayer 152 removed by the etch-back process may be no less than a thickness of a protecting layer pattern 156. If the preliminary first insulating interlayer 152 is etched by a thickness of no more than about 300 Å, the protecting layer pattern 156 may be relatively thin. The protecting layer pattern 156 may not retard or prevent chemicals from infiltrating between a first contact plug 154a (see FIG. 9) and a second contact plug 170 (see FIG. 9). If the preliminary first insulating interlayer 152 is etched by a thickness of no less than about 3,000 Å, the protecting layer pattern 156 may be relatively thick. Defects (e.g., a crack) may be generated.

A preliminary protecting layer (not shown) may be formed on the first insulating interlayer 152a to fill the gap between the preliminary first contact plugs 154. The preliminary protecting layer may include silicon nitride. The preliminary protecting layer may be then planarized until the preliminary first contact plug 154 is exposed. The protecting layer pattern 156 may be formed in the gap between the preliminary first contact plugs 154.

Referring to FIG. 11, an upper portion of the preliminary first contact plug 154 may be etched so that the first contact plug 154a having an upper face lower than an upper face of the preliminary first contact plug 154 may be formed. The protecting layer pattern 156 formed on the preliminary insulating interlayer 152a encompasses an upper sidewall of the first contact plug 154a.

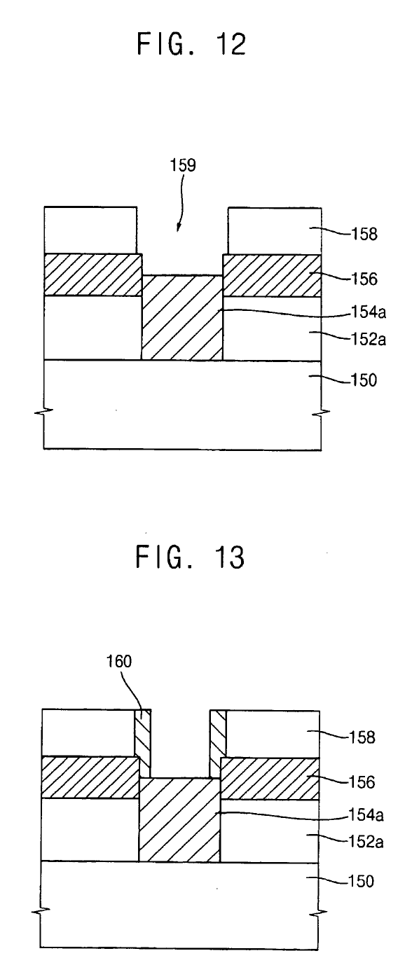

Referring to FIG. 12, a preliminary second insulating interlayer (not shown) may be on the first contact plug 154a and the protecting layer pattern 156. The preliminary second insulating interlayer may include silicon oxide. The preliminary second insulating interlayer may be formed by a CVD process.

A portion of the preliminary second insulating interlayer located on the first contact plug 154a may be then etched. A second insulating interlayer 158 having a second hole 159 may be formed. The preliminary second insulating interlayer may be initially etched by a dry etching process so that an upper face of the first contact plug 154a may be partially exposed. A wet etching process may be performed on the preliminary second insulating interlayer so that the second insulting interlayer 158 having the second hole 159 that exposes the upper face of the first contact plug 154a entirely may be formed. The second hole 159 exposes the upper sidewall of the protecting layer pattern 156.

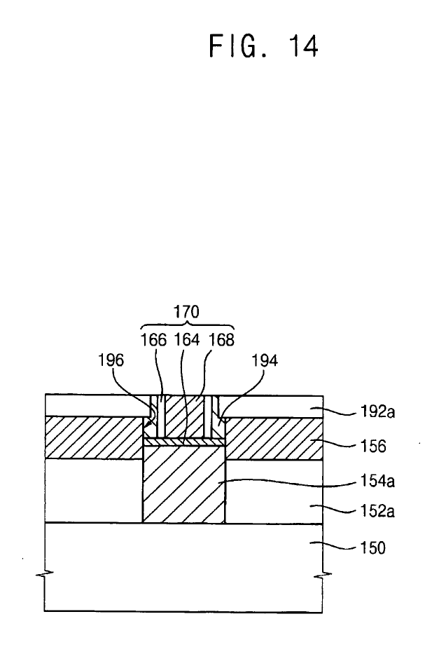

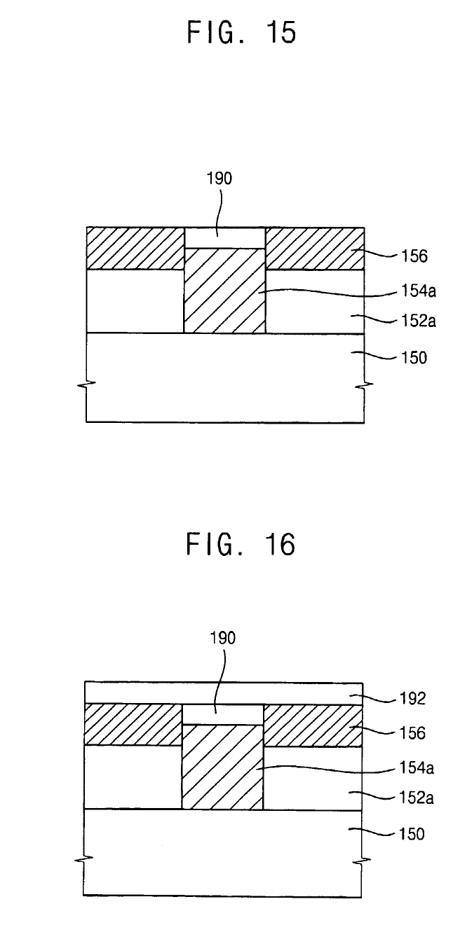

Referring to FIG. 13, an insulating layer (not shown) may be formed on the second insulating interlayer 158 and an inner face of the second hole 159. The insulating layer may be transformed into spacers. The insulating layer may include the same material as the protecting layer pattern 156. The insulating layer may include silicon nitride. The insulating layer may be formed by a CVD process.

The insulating layer may be anisotropically etched so that the spacer may be formed on a sidewall of the second hole 159. A lower portion of the spacer 160 makes contact with the protecting layer pattern 156.

Referring again to FIG. 8, a barrier metal layer (not shown) may be formed on an upper face of the second insulating interlayer 158, an upper face of the spacer 160 and a sidewall of the spacer 160. A metal silicide layer pattern 164 may be formed on an upper face of the first contact plug 154a.

A metal layer (not shown) may be formed on the barrier metal layer and the metal silicide layer pattern 164 to fill the second hole 159. The metal layer may include tungsten, aluminum or copper.

The metal layer and the barrier metal layer may be then planarized until the second insulating interlayer 158 is exposed so that a metal layer pattern 168 and a barrier metal layer pattern 166 may be formed. A second contact plug 170 including the metal silicide layer pattern 164, the metal layer pattern 168 and the barrier metal layer pattern 166 may be formed. The metal layer pattern 168 may be located on the metal silicide layer pattern 164. The barrier metal layer pattern 166 may be located at a side portion of the second contact plug 170.

The protecting layer pattern 156 covering an upper face of the first insulating interlayer 152a extends from an upper sidewall of the first contact plug 154a to a lower sidewall of the second contact plug 170. The protecting layer pattern 156 encompasses an interface between the first and second contact plugs 154a and 170. Chemicals used in an etching process for partially etching the second insulating interlayer 158 or a cleaning process may be retarded or prevented from infiltrating through the interface between the first and second contact plugs 154a and 170. Material in the first and second contact plugs 154a and 170 may be retarded or prevented from being chemically reacted with the chemicals. For example, the protecting layer pattern 156 may retard or prevent the metal silicide layer pattern 164 to be chemically reacted with the chemicals. Defects (e.g., melting and/or erosion) and contact resistance may be reduced.

FIG. 14 is a diagram illustrating a wiring structure of a semiconductor device in accordance with example embodiments. Referring to FIG. 14, a wiring structure may be the same as that shown in FIG. 8 except for a shape of a second hole 196 exposing a first contact plug 154a and a shape of a spacer 194 formed on a sidewall of the second hole 196. A second silicon oxide layer pattern 192a may be formed around the spacer 194 and on the surface of the protecting layer pattern 156. A lower portion of the second hole 196 may be wider than an upper portion of the first hole 196. A protecting layer pattern 156 may be exposed at the lower portion of the second hole 196. A lower portion of the spacer 194 may be wider than an upper portion of the spacer 194.

FIGS. 15 to 18 are diagrams illustrating a method of forming the wiring structure of the semiconductor device in FIG. 14 according to example embodiments. Referring to FIG. 15, a first insulating interlayer 152a, a first contact plug 154a and a protecting layer pattern 156 may be formed on a semiconductor substrate 150 by operations similar to those illustrated in FIGS. 9 to 11. As illustrated in FIG. 15, a preliminary first silicon oxide layer (not shown) may be formed on the protecting layer pattern 156 to fill a recess defined by the protecting layer pattern 156 and the first contact plug 154a. The preliminary first silicon oxide layer may have a first etch rate in a desired wet etching solution. The preliminary first silicon oxide layer may then be planarized until the protecting layer pattern 156 is exposed. A first silicon oxide layer 190 may be formed in the recess.

Referring to FIG. 16, a second silicon oxide layer 192 covering the first silicon oxide layer 190 and the protecting layer pattern 156 may be formed. The second silicon oxide layer 192 may have a second etch rate in the desired wet etching solution. The second etch rate may be smaller than the first etch rate. The first silicon oxide layer 190 and the second silicon oxide layer 192 may include borophosphosilicate glass (BPSG) and tetraethyl orthosilicate (TEOS), respectively.

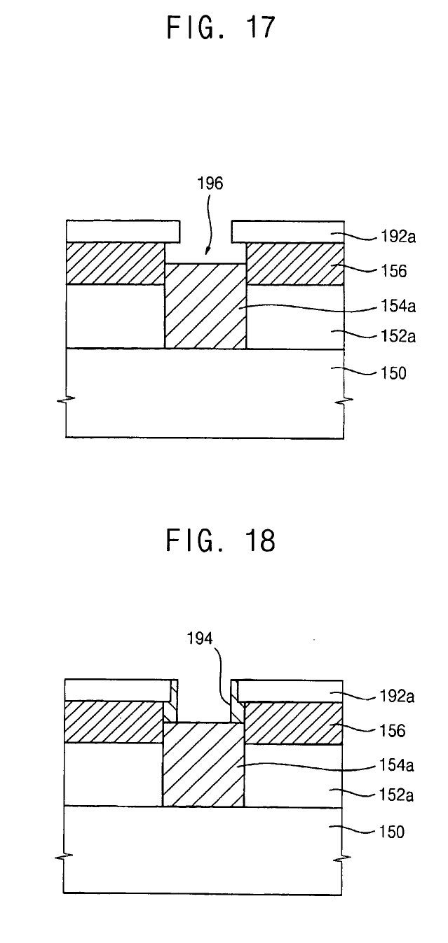

Referring to FIG. 17, a dry etching process may be performed on the first and second silicon oxide layers 190 and 192 so that a preliminary second hole (not shown) exposing an upper face of the first contact plug 154a may be partially formed. Portions of the first silicon oxide layer 190 may remain on side faces of the recess defined by the protecting layer pattern 156 and the first contact plug 154a. Portions of the second silicon oxide layer 192 may remain on the protecting layer pattern 156 as a second silicon oxide layer pattern 192a and the protecting layer pattern 156 may not be exposed.

The preliminary second hole may be enlarged by a wet etching process. The preliminary second hole may be transformed into a second hole 196 exposing an upper sidewall of the protecting layer pattern 156. The upper face of the first contact plug 154a may be entirely exposed through the second hole 196. Because the first silicon oxide layer 190 is etched faster than the second silicon oxide layer 192 by the wet etching process, a lower portion of the second hole 196 may be wider than an upper portion of the second hole 196.

Referring to FIG. 18, a spacer 194 may be formed on a sidewall of the second hole 196. The spacer 194 may include the same material as the protecting layer pattern 156. A lower portion of the spacer 194 may be wider than an upper portion of the spacer 194. Referring again to FIG. 14, a metal silicide layer pattern 164 may be formed on a bottom face of the second hole 196. A barrier metal layer pattern 166 may be formed on a sidewall of the spacer 166. A metal layer pattern 168 may be formed in the second hole 196 partially filled with the spacer 194 and the barrier metal layer patterns 166. A second contact plug 170, making electrical contact with the first contact plug 154a, may be formed. As described above, the lower portion of the second hole 196 may be wider than the upper portion of the second hole 196. An area may increase where the first contact plug 154a makes electrical contact with the second contact plug 170.

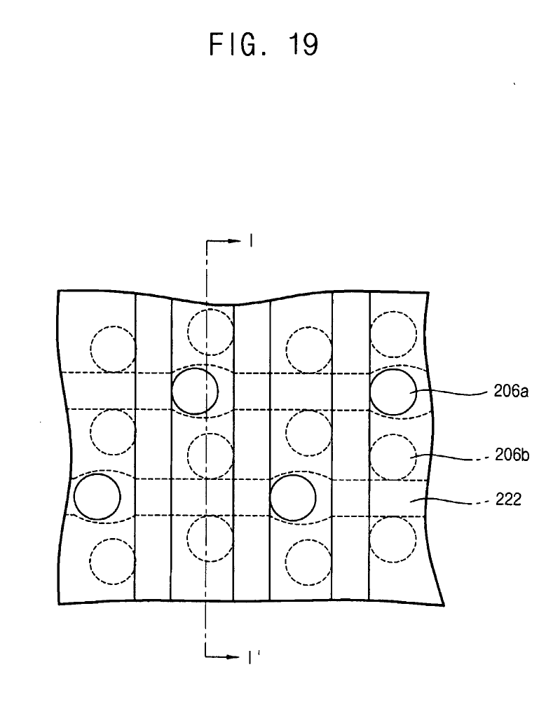

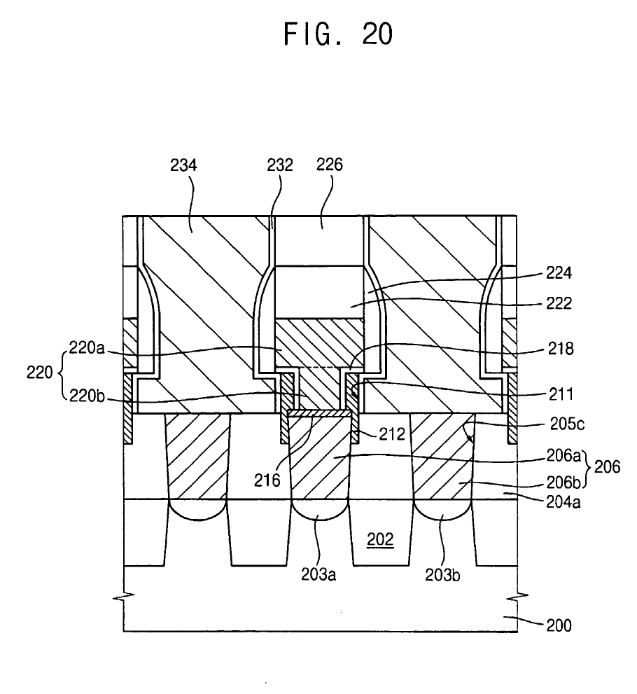

FIG. 19 is a diagram illustrating a dynamic random access memory (DRAM) device including the wiring structure in FIG. 1 according to example embodiments. FIG. 20 is a diagram taken along line I-I′ in FIG. 19 according to example embodiments.

Referring to FIGS. 19 and 20, a semiconductor substrate 200, having a surface at which an isolation layer 202 may be formed, may be prepared. The isolation layer 202 may divide the semiconductor substrate 200 into an isolation region and a plurality of active regions 202. The isolation layer 202 may correspond to the isolation region. The isolation region may isolate the active regions from one another. Gate structures may be formed on the isolation region and the active regions. The gate structures may extend in a first direction. The gate structures may be parallel with one another. For example, two gate structures may be provided on each of the active regions. The active region may extend in a second direction different from the first direction. For example, the second direction may form an acute angle with the first direction. For another example, the second direction may form a right angle with the first direction. For still another example, the second direction may form an obtuse angle with the first direction.

A metal oxide semiconductor (MOS) transistor may be provided on the active region. The MOS transistor may include the gate structure extending in the first direction on the active region, a first impurity region 203a and a second impurity region 203b. The gate structure may have a bar shape. The first and second impurity regions 203a and 203b may be formed in a surface of the active region. The first and second impurity regions 203a and 203b may be located below opposite sides of the gate structure. The first impurity region 203a and the second impurity region 203b may be used as a first source/drain region and a second source/drain region, respectively. The gate structure may include a gate oxide layer, a gate conductive layer pattern and a hard mask layer pattern. The gate conductive layer pattern may be formed on the gate oxide layer. The hard mask layer pattern may be formed on the gate conductive layer pattern. A gate spacer may be formed on a sidewall of the gate structure.

The first impurity region 203a may be located at a central portion of the active region. Also, the second impurity region 203b may be located at an end portion of the active region. A bit line may make electrical contact with the first impurity region 203a. A capacitor may make electrical contact with the second impurity region 203b. A first insulating interlayer 204a covering the gate structure may be provided. The first insulating interlayer 204a may include silicon oxide. First holes 205c may be formed through the first insulating interlayer 204a. First hole 205c may expose the first impurity region 203a and/or the second impurity region 203b.

A first contact plug 206 may be formed in the first hole 205c. The first contact plug 206 may include polysilicon. The first contact plug 206, electrically connected to the first impurity region 203a, may be referred to as a bit line contact plug 206a. Also, the first contact plug 206, electrically connected to the second impurity region 203b, may be referred to as a capacitor contact plug 206b. The first contact plug 206 may be formed by a self-alignment process such that the first contact plug 206 is aligned with respect to the gate spacer formed on the sidewall of the gate structure. When the first contact plug 206 is formed, the gate spacer may guide the first contact plug 206 such that the first contact plug 206 makes precise contact with the first impurity region 203a and/or the second impurity region 203b. A second insulating interlayer (not shown) may be formed on the first insulating interlayer 204a through which the first contact plugs 206 are formed. Second holes 211 may be formed through the second insulating interlayer. The second holes 211 may expose some bit line contact plugs 206a selectively.

A bit line structure 220 may be formed in the second hole 211. The bit line structure 220 may be electrically connected to the bit line contact plug 206a. A hard mask layer pattern 222 may be formed on the bit line structure 220. A spacer 224 may be formed on a sidewall of the bit line structure 220. The bit line structure may include a metal having an electrical resistance lower than polysilicon.

The bit line structure 220 may include a bit line 220a and a bit line contact 220b. The bit line contact 220b may make electrical contact with the bit line contact plug 206a. The bit line 220a may make electrical contact with the bit line contact 220b. A metal silicide layer pattern 216 may be formed between the bit line contact 220b and the bit line contact plug 206a. The metal silicide layer pattern 216 may serve as an ohmic layer reducing contact resistance. A barrier metal layer pattern 218, having a thickness of a few angstroms to hundreds of angstroms, may be formed on a sidewall of the bit line contact 220b and a lower face of the bit line 220a. The barrier metal layer pattern 218 may include a titanium film and/or a titanium nitride film. The metal silicide layer pattern 216 may include titanium silicide. The metal included in the bit line 220a and a bit line contact 220b may be tungsten.

A protecting layer pattern 212 may be provided. The protecting layer pattern 212 may have a tubular shape so that the protecting layer pattern 212 encompasses an upper sidewall of the bit line contact plug 206a and a sidewall of the bit line contact 220b. The protecting layer pattern 212 may retard or prevent chemicals from infiltrating between the bit line contact plug 206a and the bit line structure 220. The protecting layer pattern 212 may include material that is barely removed while the first insulating interlayer 204a and the second insulating interlayer may be etched. When the first insulating interlayer 204a and the second insulating interlayer include silicon oxide, the protecting layer pattern 212 may include silicon nitride.

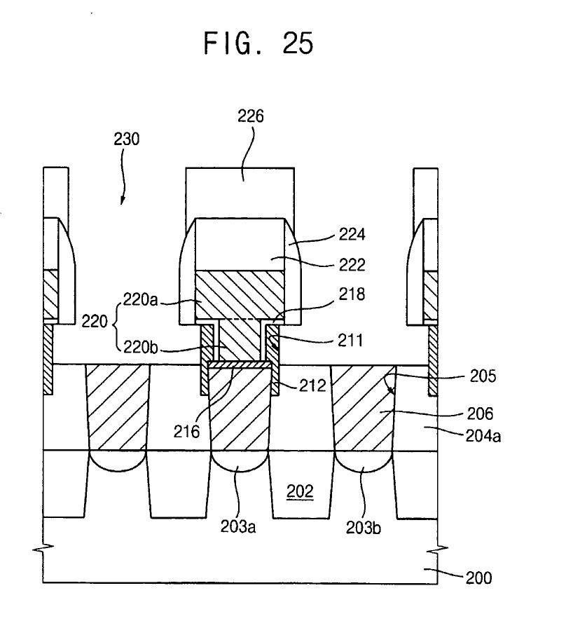

Because of the protecting layer pattern 212, defects (e.g. melting and/or erosion) in the metal silicide layer pattern 216, due to the infiltration of the chemicals, may be reduced. The protecting layer pattern 212 formed on a sidewall of the second hole 211 may retard or prevent the bit line 220a from being electrically connected to conductive patterns neighboring the bit line 220a. A third insulating interlayer 226 covering the bit line structure 220 may be formed. Third holes 230 (see FIG. 25), each exposing the capacitor contact plugs 206b, may be formed through the third insulating interlayer 226. The third hole 230 may be formed by a self-aligned process so that the third hole 230 may be aligned with respect to a spacer 224 formed on a sidewall of the bit line structure 220. When the third hole 230 is formed, the spacer 224 may guide the third hole 230 so that the third hole 230 exposes the capacitor contact plug 206b.

A lower portion of the third hole 230 may be wider than an upper portion of the third hole 230. An outer sidewall of the protecting layer pattern 212 may be exposed at the lower portion of the third hole 230. The upper face of the capacitor contact plug 206b may be entirely exposed through the third hole 230. An inner spacer 232 may be formed on a sidewall of the third hole 230. The inner spacer 232 may insulate the bit line structure 220 electrically. A storage node contact 234 may be formed in the third hole 230. The storage node contact may include conductive material (e.g., polysilicon doped with impurities). Although not particularly illustrated in the figures, a capacitor may be formed on the storage node contact 234.

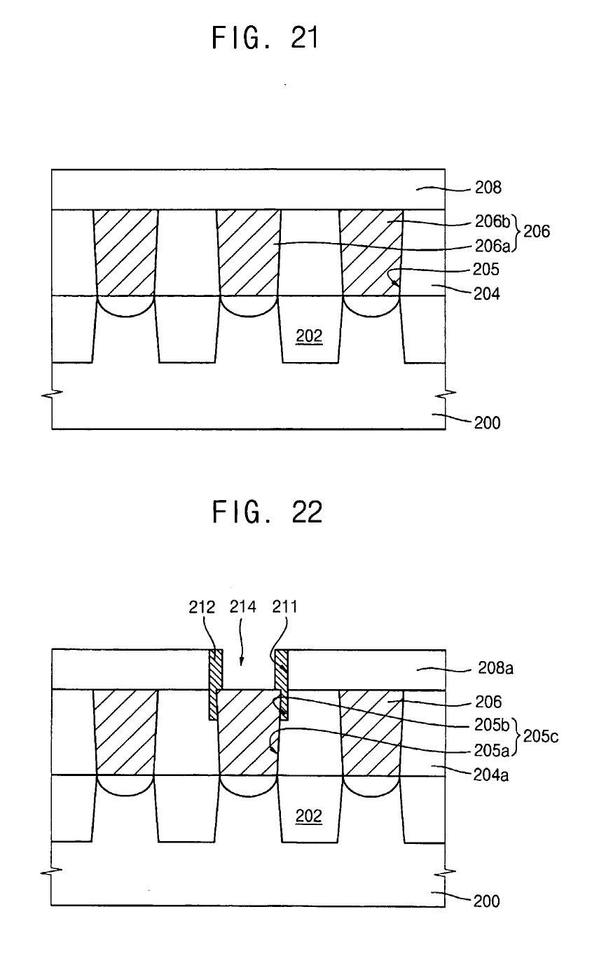

FIGS. 21 to 25 are diagrams illustrating a method of manufacturing a DRAM device in FIG. 20 according to example embodiments. Referring to FIG. 21, an isolation layer 202 may be formed in a surface of a semiconductor substrate 200 by a trench isolation process. The isolation layer 202 may divide the semiconductor substrate 200 into a field region and a plurality of active regions. The isolation layer 202 may be the field region. The field region may isolate the active regions from one another. Gate structures may be formed on the field region and the active regions. The gate structure may extend in a first direction. The gate structures may be parallel with one another. For example, two gate structures may be provided on each of the active regions. The active region may extend in a second direction different from the first direction. As one example, the second direction may form an acute angle with the first direction. As another example, the second direction may form a right angle with the first direction. As still another example, the second direction may form an obtuse angle with the first direction.

In the trench isolation process, a buffer oxide layer (not shown) may be initially formed on the semiconductor substrate 200. A silicon nitride layer may then be formed on the buffer oxide layer. The buffer oxide layer may reduce the stress generated between the semiconductor substrate 200 and the silicon nitride layer. The silicon nitride layer may be etched so that a silicon nitride layer (not shown) may be formed. The buffer oxide layer and the semiconductor substrate 200 may be etched using the silicon nitride layer pattern as an etch mask so that a trench having a desired depth may be formed. A silicon oxide layer may then be formed on the silicon nitride layer pattern so that the silicon oxide layer fills the trench. The silicon oxide layer may be planarized until the silicon nitride layer pattern is exposed. The isolation layer 202, corresponding to the field region, may be formed in the trenches. Portions of the semiconductor substrate 200 may be isolated from one another by the isolation layer 202 corresponding to each of the active regions. The silicon nitride layer pattern and the buffer oxide layer pattern may then be removed by a wet etching process.

A thermal oxidation process may be performed on the active region so that a gate oxide layer may be formed. A gate conductive layer may then be formed on the gate oxide layer. A hard mask layer may be formed on the gate conductive layer. The gate conductive layer and the hard mask layer may be successively etched so that a gate structure including the gate oxide layer, a gate conductive layer pattern and a hard mask layer pattern may be formed. Two gate structures may be provided on each of the active regions. The gate structures may be parallel with one another.

A gate spacer may be formed on a sidewall of the gate structure. The gate spacer may include silicon nitride. Impurities may be implanted into the active region by using the gate structure as a mask. First and second impurity regions 203a and 203b may be formed on a surface of the active region. The first and second impurity regions 203a and 203b may be located below opposite sides of the gate structure. The first impurity region 203a and the second impurity region 203b may be used as a first source/drain region and a second source/drain region, respectively. The first impurity region 203a may be located at a central portion of the active region. The second impurity region 203b may be formed at an end portion of the active region. A bit line may make electrical contact with the first impurity region 203a and a capacitor may make electrical contact with the second impurity region 203b.

A preliminary first insulating interlayer 204 may be formed to cover the gate structure. The preliminary first insulating interlayer 204 may be formed by a CVD process and/or any other suitable process. The preliminary first insulating interlayer 204 may include silicon oxide. The preliminary first insulating interlayer 204 may be etched so that a preliminary first hole 205, exposing the first and second impurity regions 203a and 203b, may be formed through the preliminary first insulating interlayer 204. The preliminary first hole 205 may be formed by a self-alignment process such that the preliminary first hole 205 may be aligned with respect to the gate spacer. When the first insulating interlayer 204 is etched to form the preliminary first hole 205, the gate spacer may guide the preliminary first hole 205 such that the preliminary first hole 205 expose the first impurity region 203a and/or the second impurity region 203b precisely.

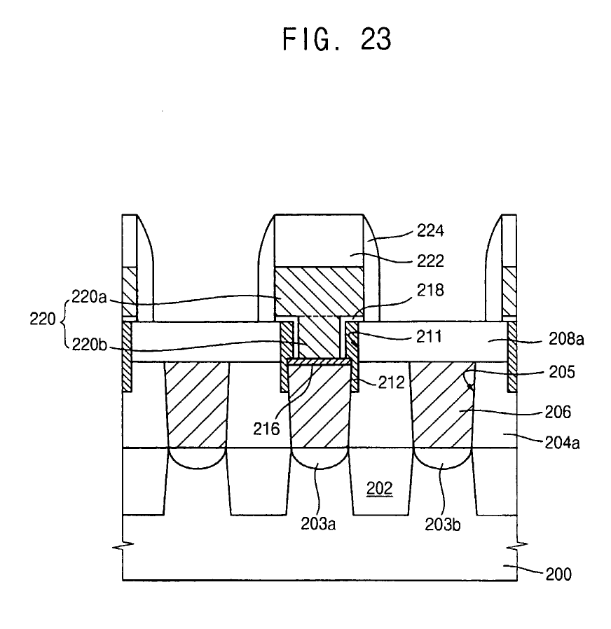

A polysilicon layer doped with impurities may be formed on the preliminary first insulating interlayer 204 to fill the preliminary first holes 205. The polysilicon layer may be planarized until the preliminary first insulating interlayer 204 is exposed. A bit line contact plug 206a and a capacitor contact plug 206b may be formed. The bit line contact plug 206a may make electrical contact with the first impurity region 203a and the capacitor contact plug 206b may make electrical contact with the second impurity region 203b. A preliminary second insulating interlayer 203 may be formed on the preliminary first insulating interlayer 208 through which the first contact plug 206 may be formed. The preliminary second insulating interlayer 208 may be formed by a CVD process and/or any other suitable process. The preliminary second insulating interlayer 208 may include silicon oxide. The thickness of the preliminary second insulating interlayer 208 may be no less than that of a bit line contact 220b (see FIG. 23).

Referring to FIG. 22, a photoresist pattern (not shown), exposing the bit line contact plug 206a and a portion of the preliminary second insulating interlayer 208, the portion being located around the bit line contact plug 206a, may be formed on the preliminary second insulating interlayer 208.

The preliminary second insulating interlayer 208 may be etched using the photoresist pattern as an etch mask. An upper portion of the preliminary first insulating interlayer 204 may then be etched. The preliminary second insulating interlayer 208 may be transformed into a second insulating interlayer 208a having a second hole 211 exposing the bit line contact plug 206a. The preliminary first insulating interlayer 204 may be transformed into a first insulating interlayer 204a having holes 205c in contact with the second hole 211. The holes 205c may have a first hole 205a and a second hole 205b. The first hole 205a and the second hole 205b may correspond to a lower portion of the holes 205c and an upper portion of the holes 205c, respectively. The first hole 205a may be in contact with the second hole 205b. The first hole 205a and the second hole 205b may have a first width and a second width, respectively. The second width may be larger than the first width. A spacer, having a tubular shape, may be formed between the first contact plug 206 and the second hole 205b of the first hole 205c.

While the preliminary second insulating interlayer 208 and the preliminary first insulating interlayer 204 are etched, the hard mask layer pattern of the gate structure may be exposed. When the preliminary first insulating interlayer 204 is etched, the capacitor contact plug 206b, adjacent to a sidewall of the second hole 205b, may not be exposed. A silicon nitride layer (not shown) may be continuously formed on a sidewall of the second hole 211 and a surface of the bit line contact plug 206a. The silicon nitride layer may fill the space between the first contact plug 206 and the second hole 205b of the first hole 205c. As described above, the spacer may have the tubular shape.

The silicon nitride layer may be anisotropically etched until the bit line contact plug 206a is exposed. A protecting layer pattern 212 filling the space may be formed. The protecting layer pattern 212 may extend to a sidewall of the second hole 211. The protecting layer pattern 212 may have a tubular shape so that the protecting layer pattern 212 may encompass an upper sidewall of the bit line contact plug 206a. The protecting layer pattern 212 may have an upper face higher than an upper face of the first contact plug 206a. For example, the upper face of the protecting layer pattern 212 and an upper face of the second insulating interlayer 208a may be coplanar. For another example, the upper face of the protecting layer pattern 212 may be lower than the upper face of the second insulating interlayer 208a.

The protecting layer pattern 212 may retard or prevent a width of the second hole 211 of the protecting layer pattern 212 may be inevitably enlarged while succeeding processes are performed. The protecting layer pattern 212 may retard or prevent chemicals used in the succeeding processes from infiltrating through an inner face of the second hole 211.

Referring to FIG. 23, a barrier metal layer may be formed on an upper face of the second insulating interlayer 208a, an upper face of the protecting layer pattern 212 and a sidewall of the protecting layer pattern 212. A metal silicide layer pattern 216 may be formed on an upper face of the bit line contact plug 206a. The barrier metal layer and the metal silicide layer may be formed by operations already illustrated in FIG. 7.

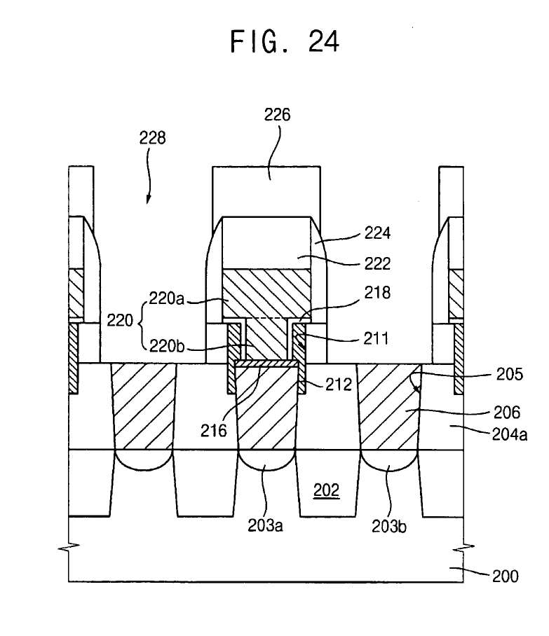

A metal layer (not shown) may be formed on the second insulating interlayer 208a to fill the second hole 211. The metal layer may include tungsten, aluminum and/or copper. For example, the metal layer may include tungsten, because tungsten is thermally stable. The metal layer may be transformed into a bit line structure 220 (see FIG. 24) by succeeding processes. The metal layer may have an adequate thickness so that the bit line structure 220 may have a relatively low electrical resistance. After the metal layer is formed, a planarizing process (e.g. a chemical mechanical polishing process) may be further performed on the metal layer to planarize a surface of the metal layer.

A hard mask layer (not shown) may be formed on the metal layer. The hard mask layer may be partially etched so that hard mask layer patterns 222 used for patterning the metal layer into the bit line structure 220 may be formed. The hard mask layer pattern 222 may have a bar shape extending in a direction perpendicular to a direction in which the gate structure extends.

The metal layer and the barrier metal layer may be etched using the hard mask layer patterns 222 together as an etch mask so that the bit line structure 220 and a barrier metal layer pattern 218 may be formed. The bit line structure 220 may include a bit line contact 220b and a bit line 220a. The barrier metal layer pattern 218 may be formed on a sidewall of the bit line contact 220b and a lower face of the bit line 220a. A silicon nitride layer may be formed on the bit line structure 220, the hard mask layer pattern 222 and the second insulating interlayer 208a. The silicon nitride layer may be anisotropically etched to form a spacer 224 on sidewalls of the bit line structure 220 and the hard mask layer pattern 222. The spacer 224 may protect the bit line structure 220.

Referring to FIG. 24, a preliminary third insulating interlayer (not shown) may be formed on the second insulating interlayer 208a to cover the bit line structure 220. The preliminary third insulating interlayer may include silicon oxide. The preliminary third insulating interlayer may be formed by a CVD process and/or any other suitable process. The preliminary third insulating interlayer and the second insulating interlayer 208a may be etched so that a preliminary third hole 228, exposing an upper face of the capacitor contact plug 206b, may be formed through the third insulating interlayer and the second insulating interlayer. The preliminary third hole 228 may be formed by a self-alignment process such that the preliminary third hole 228 may be aligned with respect to the spacer 224. When the preliminary third hole 228 is formed, the spacer 224 may guide the preliminary third hole 228 to expose the upper face of the capacitor contact plug 206b. A wet etching process may be performed on the preliminary third hole 228 so that a lower portion of the preliminary third hole 228 may be enlarged. A third insulating interlayer 226, having a third hole 230, may be formed.

Referring to FIG. 25, a portion of the second insulating interlayer located under the spacer 224 may be removed by the wet etching process. An outer sidewall of the protecting layer pattern 212 may be exposed. An example of an etching solution used in the wet etching process may include a limulus amebocyte lysate (LAL) solution. The LAL solution may include ammonium fluoride, hydrogen fluoride and/or water. Residuals and particles may be removed from the preliminary third hole 230 by the wet etching process.

If the protecting layer pattern 212 is not formed or if the protecting layer pattern 212 incompletely encompasses the interface between the bit line contact plug 206a and the bit line contact 220b, chemicals may infiltrate into the interface between the bit line contact plug 206a and the bit line contact 220b. If the chemicals infiltrate into the interface, the chemicals may damage the metal silicide layer pattern 216 between the bit line contact plug 206a and the bit line contact 220b. If the etching solution used for etching the first insulating interlayer and the second insulating interlayer 208a infiltrates into the interface, the etching solution may melt the metal silicide layer pattern 216. Holes may be generated in the metal silicide layer pattern 216. Contact resistance between the bit line contact plug 206a and the bit line contact 220b may increase.

However, the protecting layer pattern 212 having a tubular shape may enclose the upper sidewall of the bit line contact plug 206a and the sidewall of the bit line contact 220b entirely such that the protecting layer pattern 212 may encompass the interface between the bit line contact plug 206a and the bit line contact 220b entirely. Because the protecting layer pattern 212 retards or prevents chemicals from infiltrating into the interface, relatively low contact resistance may be maintained.

Referring again to FIG. 20, an inner spacer 232 may be formed on a sidewall of the third hole 230. The inner spacer 232 may insulate the bit line structure 220 electrically. A conductive layer including a conductive material may be formed on the third insulating interlayer 226 to fill the third hole 230. Polysilicon doped with impurities may be used as the conductive material because polysilicon doped with impurities may be capable of achieving conformal step coverage. The conductive layer may then be planarized until the third insulating interlayer 226 is exposed so that a storage node contact 240 may be formed.

Although not illustrated in the figures, a capacitor making electrical contact with the storage node contact 240 may be formed so that a DRAM device may be manufactured. Although not described, methods of forming a contact plug illustrated in FIGS. 9 to 13 or FIGS. 15 to 18 may be employed to form a first contact plug (e.g. used as a landing pad of a DRAM device) and a bit line contact. A DRAM device having a protecting layer pattern extending from an upper sidewall of the first contact plug to a lower sidewall of the bit line contact may be manufactured.

According to example embodiments, damage to a metal silicide layer pattern, used as an ohmic layer pattern in a wiring structure of a semiconductor device, may be reduced. Electrical resistance of the wiring structure may be relatively low and connection of the wiring structure may be improved. Characteristics (e.g. operation characteristics, reliability, and/or a yield) of the semiconductor device may increase.

The foregoing is illustrative of example embodiments and is not to be construed as limiting thereof. Although a few embodiments have been described, those skilled in the art will readily appreciate that many modifications are possible in the embodiments without materially departing from the novel teachings and advantages of example embodiments. Accordingly, all such modifications are intended to be included within the scope of the claims. Therefore, it is to be understood that the foregoing is illustrative of example embodiments and is not to be construed as limited to the specific embodiments disclosed, and that modifications to the disclosed embodiments, as well as other embodiments, are intended to be included within the scope of the appended claims. Example embodiments are defined by the following claims, with equivalents of the claims to be included therein.

What is claimed is:

1. A wiring structure, the wiring structure comprising:
a first contact plug provided on a semiconductor substrate;
a second contact plug provided on the first contact plug to be electrically connected to the first contact plug;
a protecting layer pattern encompassing an upper sidewall of the first contact plug and a sidewall of the second contact plug to retard chemicals from infiltrating into an interface between the first and second contact plugs; and
an insulating structure encompassing the first contact plug, the second contact plug and the protecting layer pattern.

2. The wiring structure of claim 1, wherein the first contact plug includes polysilicon doped with impurities and the second contact plug includes material having metal.

3. The wiring structure of claim 2, further comprising:
a metal silicide layer pattern used as an ohmic layer pattern at a lower face portion of the second contact plug, the lower face portion making direct contact with the first contact plug.

4. The wiring structure of claim 3, wherein the metal silicide layer pattern includes titanium silicide.

5. The wiring structure of claim 1, wherein the protecting layer pattern includes silicon nitride.

6. The wiring structure of claim 1, wherein the protecting layer pattern has a tubular shape.

7. The wiring structure of claim 1, wherein the insulating structure includes at least one insulating interlayer and the protecting layer pattern is entirely formed on an upper face of a first insulating interlayer provided between the first and second contact plugs.

8. The wiring structure of claim 1, further comprising:
a spacer provided between the second contact plug and the protecting layer pattern.

9. The wiring structure of claim 1, further comprises:
a conductive line provided on the second contact plug and the insulating structure, the conductive line being electrically connected to the second contact plug.

10. The wiring structure of claim 1, further comprising:
the insulating structure including at least two insulating interlayers; and
a third contact plug provided through the insulating structure, the third contact plug having a sidewall making contact with the protecting layer pattern.

11. A method of forming a wiring structure, the method comprising:
forming a first contact plug through a first insulating interlayer formed on a semiconductor substrate;
forming a second insulating interlayer on the first insulating interlayer;
partially etching the first and second insulating interlayers, thereby forming first and second holes exposing an upper face of the first contact plug and an upper sidewall of the first contact plug;
forming a protecting layer pattern encompassing the exposed upper sidewall of the first contact plug, the protecting layer pattern having an upper face at a height greater than an upper face of the first contact plug; and
forming a second contact plug in the first and second holes, the second contact plug making electrical contact with the first contact plug.

12. The method of claim 11, wherein forming the protecting layer pattern includes:
continuously forming a protecting layer on an upper face of the second insulating layer, a sidewall of the first and second holes and an upper face of the first contact plug to fill a gap between the first contact plug and the first and second holes; and
anisotropically etching the protecting layer such that portions of the protecting layer selectively remain on the sidewall of the first and second holes and a sidewall of the first contact plug.

13. The method of claim 11, wherein the protecting layer is formed of silicon nitride.

14. The method of claim 11, wherein forming the second contact plug includes:
forming a metal silicide layer pattern on the upper face of the first contact plug; and
forming a metal layer to fill the first and second holes.

15. The method of claim 11, further comprising:
forming a third insulating interlayer on the second insulating interlayer through which the second contact plug is formed;
forming a third preliminary hole by etching portions of the third and second insulating interlayers, the portions being adjacent to the protecting layer pattern;
enlarging a lower portion of the third preliminary hole such that a sidewall of the protecting layer pattern is exposed to thereby form a third hole exposing a contact region; and
forming a conductive layer on an inner face of the third hole.

16. The method of claim 15, wherein enlarging the lower portion of the third preliminary hole is performed using a wet etching process.

17. A method of forming a wiring structure, the method comprising:
forming a preliminary first insulating interlayer including a preliminary contact plug on semiconductor substrate;
performing an etch-back process on an upper portion of the preliminary first insulating interlayer to form a first insulating interlayer covering a lower sidewall of the preliminary first contact plug such that an upper sidewall of the preliminary first contact plug is exposed;
forming a protecting layer pattern on the first insulating interlayer, the protecting layer pattern having an upper face coplanar with an upper face of the preliminary first contact plug;
performing an etch-back process on an upper portion of the preliminary first contact plug to form a first contact plug having a height lower than that of the preliminary first contact plug;
forming a second insulating interlayer on the protecting layer pattern and the first insulating interlayer, the second insulating interlayer having a hole exposing a sidewall of the protecting layer pattern and an upper face of the first contact plug; and
forming a second contact plug on the first contact plug to make electrical contact with the first contact plug, the second contact plug filling the hole.

18. The method of claim 17, further comprising:
forming a spacer on a sidewall of the hole and a sidewall of the protecting layer pattern.

19. The method of claim 17, wherein forming the second insulating interlayer having the hole includes:
forming an insulating layer on the protecting layer pattern and the first contact plug such that the insulating layer fills a gap defined by the protecting layer pattern and the first contact plug;
partially etching the insulating interlayer to form a preliminary hole exposing an upper face of the first contact plug; and
enlarging the preliminary hole to form a hole exposing a sidewall of the protecting layer pattern, the hole having a width larger than that of the preliminary hole.

20. The method of claim 19, wherein forming the insulating interlayer includes:
forming a lower insulating interlayer filling the gap defined by the protecting layer pattern and the first contact plug, the lower insulating interlayer having a first etch rate under a desired etching condition; and
forming an upper insulating interlayer on the lower insulating interlayer, the upper insulating interlayer having a second etch rate under the desired etching condition, the second etch rate being lower than the first etch rate.

21. A semiconductor device comprising:
a substrate;
an isolation layer dividing the substrate into an isolation region and a plurality of active regions;
gate structures on the isolation region and the plurality of active regions;
a metal oxide semiconductor transistor on the plurality of active regions that includes first and second impurity regions located below opposite sides of the gate structures;
a bit line in electrical contact with the first impurity region and a capacitor in electrical contact with the second impurity region;
a first insulating interlayer covering the gate structures and including first and second holes exposing the first impurity region or the second impurity region; and
the wiring structure of claim 1.

22. A method of manufacturing a semiconductor device comprising:
forming an isolation layer in a surface of a semiconductor substrate that may divide the semiconductor substrate into a field region and a plurality of active regions;
forming gate structures on the field region and the plurality of active regions;
sequentially forming a buffer oxide layer and silicon nitride layer on the semiconductor substrate;
etching the silicon nitride layer to form a silicon nitride layer pattern;
removing the silicon nitride layer pattern and the buffer oxide layer pattern by a wet etching process;
forming first and second impurity regions on a surface of the active region located below opposite sides of the gate structures;
electrically connecting a bit line and the first impurity region, and a capacitor and the second impurity region; and
forming a wiring structure according to claim 17.
